(19) United States
(12) Patent Application Publication
(10) Pub. No.: US 2025/0370714 A1
(43) Pub. Date: Dec. 4, 2025

(54) TILED ARTIFICIAL INTELLIGENCE ACCELERATOR WITH FINE-GRAINED ACTIVATION REUSE FOR MINIMIZED MEMORY STORAGE AND ACCESS

(71) Applicant: Taiwan Semiconductor Manufacturing Company, Ltd., Hsinchu (TW)

(72) Inventors: Xiaochen Peng, Hsinchu City (TW); Murat Kerem Akarvardar, Xinfeng Township (TW)

(73) Assignee: Taiwan Semiconductor Manufacturing Company, Ltd., Hsinchu (TW)

(21) Appl. No.: 18/675,866

(22) Filed: May 28, 2024

(51) Int. Cl. G06F 7/544; G06F 17/15

(52) U.S. Cl. CPC G06F 7/5443; G06F 17/15

(57) ABSTRACT

Systems, devices, circuits, and methods of operating said systems, devices, and circuits are disclosed. In one aspect, a system includes an input buffer circuit storing a set of data values for a convolution operation and a plurality of multiply-accumulate (MAC) circuits. A first MAC circuit of the plurality of MAC circuits can retrieve the set of data values for the convolution operation and generate a first output by applying a first weight value stored at the first MAC circuit to a first data value of the set of data values. The first MAC circuit can provide the first data value to a second MAC circuit of the plurality of MAC circuits. The first MAC circuit can generate a plurality of second outputs by applying a second weight value and a third weight value stored at the first MAC circuit to a second data value of the set of data values.

### BACKGROUND

An integrated circuit (IC) can contain a variety of hardware circuit devices or types of logic, including FPGAs, application-specific integrated circuits (ASICs), logic gates, registers, or transistors, in addition to various interconnections between the circuit devices. The IC can be manufactured using or composed of semiconductor materials, for instance, as part of electronic devices, such as computers, portable devices, smartphones, internet of thing (IoT) devices, etc. Developments and increasing complexity of the ICs have prompted increased demands for higher computational efficiency and speed. More specifically, the ICs can be configurable and/or programmable to perform computations in sequences or variations desired by the manufacturer, developer, technician, or programmer, among others.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a block diagram of an example two-dimensional (2D) tiled multiply-accumulate (MAC) circuit implemented to accelerate artificial intelligence operations, in accordance with some embodiments of the present disclosure.

FIG. 2 illustrates a block diagram of an example input register included in a processing element of the tiled MAC circuit of FIG. 1, in accordance with some embodiments of the present disclosure.

FIGS. 3A and 3B illustrate dataflow diagrams illustrating how information is processed and propagated through the tiled MAC circuit architectures described herein, in accordance with some embodiments of the present disclosure.

FIG. 4 illustrates a block diagram illustrating how data is arranged to process certain convolution operations using the tiled MAC circuit architectures described herein, in accordance with some embodiments of the present disclosure.

FIG. 5 illustrates a dataflow diagram illustrating how information stored according to the arrangement shown in FIG. 4 is processed and propagated through the tiled MAC circuit architectures described herein, in accordance with some embodiments of the present disclosure.

FIG. 6 illustrates a block diagram of an example three-dimensional (3D) tiled MAC circuit implemented to accelerate artificial intelligence operations, in accordance with some embodiments of the present disclosure.

FIG. 7 illustrates a block diagram of an example adder circuit implemented as part of a tier of the 3D tiled MAC architecture shown in FIG. 6, in accordance with some embodiments of the present disclosure.

FIG. 8 illustrates a block diagram of another example adder circuit implemented as part of a tier of the 3D tiled MAC architecture shown in FIG. 6, in accordance with some embodiments of the present disclosure.

FIGS. 9, 10, 11, and 12 illustrate diagrams showing steps for data processing operations using the 3D tiled MAC circuit shown in FIG. 6, in accordance with some embodiments of the present disclosure.

FIG. 13 illustrates a block diagram of an example implementation of the tiled MAC accelerator circuits described herein using an input stationary configuration, in accordance with some embodiments of the present disclosure.

FIG. 14 illustrates cross-sectional diagrams of an example semiconductor layout of the 3D tiled MAC circuits described herein, in accordance with some embodiments of the present disclosure.

FIG. 15 illustrates a flowchart of an example method to operate the disclosed circuits described herein, in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over, or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” “top,” “bottom” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Artificial intelligence (AI) operations, such as MAC operations and convolution operations, are often memory constrained due to the large amounts of information that are to be propagated through circuitry responsible for performing said operations. Conventional approaches for accelerating AI operations often focus on improving computational efficiency without addressing memory bandwidth issues. As a result, conventional approaches include delays in which computational circuitry is idle while data that is to be processed (e.g., input data, weight data from artificial intelligence models, etc.) is accessed, retrieved, and loaded into appropriate registers/memory elements.

In the aggregate, these memory access delays significantly degrade the performance of conventional artificial intelligence accelerator circuits. Moreover, approaches to process convolutional operations involve storing highly duplicated data or implementing particular memory access schedulers that access and retrieve different groups of input data into appropriate processing elements. Other approaches for addressing these issues involve storing highly duplicated data or implementing particular memory access schedulers that access and retrieve different groups of input data into appropriate processing elements. Each of these approaches has numerous drawbacks, including excessive memory storage, excessive power consumption, and impractically large circuit routing complexity or area usage. Such approaches are particularly impractical when implementing accelerators to process large amounts of input data for large artificial intelligence models. These approaches are therefore becoming increasing impractical as the use and size of artificial intelligence models increases exponentially.

To address these and other issues, the systems and methods of the present disclosure provide techniques to implement accelerator circuits that include multiple processing elements that reuse input data to reduce data duplication. To do so, additional input registers and routing circuitry are implemented in each processing element, which iteratively propagate reusable input data to subsequent processing elements. The reuse of input data in local storage across sequential processing elements increases overall device throughput and reduces the occurrence and impact of the aforementioned memory access delays. As the present techniques do not require needless duplication of data or highly complex routing or scheduling circuits, the present techniques reduce overall power and area consumption relative to other approaches.

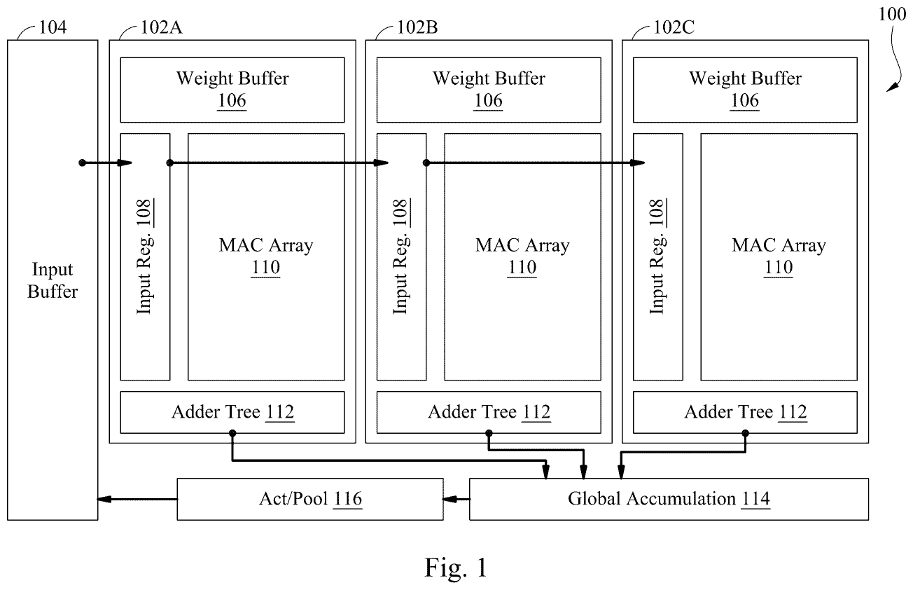

FIG. 1 illustrates a block diagram of an example 2D tiled MAC circuit 100 implemented to accelerate artificial intelligence operations, in accordance with some embodiments of the present disclosure. Tiled MAC circuit 100 shown in FIG. 1 can be used to implement any artificial intelligence operation involving a MAC operation. For example, tiled MAC circuit 100 can be used to perform convolution operations (e.g., for one layer of a convolutional neural network, etc.). In some implementations, and as shown in this example, tiled MAC circuit 100 can include an activation and pooling circuit 116, which may perform one or more activation function operations and/or pooling operations on the convolutional output of tiled MAC circuit 100.

Tiled MAC circuit 100 may include one or more logic gates and sub-circuits, each of which may be constructed from one or more logic gates. Logic gates are electronic devices that perform logical operations on one or more input signals to produce a single output signal. Various embodiments of the circuits and logic gates that implement tiled MAC circuit 100 may include various transistors. The transistors described herein may have a certain type (n-type or p-type), but embodiments are not limited thereto. The transistors can be any suitable type of transistor including, but not limited to, metal oxide semiconductor field effect transistors (MOSFET), complementary metal oxide semiconductors (CMOS) transistors, P-channel metal-oxide semiconductors (PMOS), N-channel metal-oxide semiconductors (NMOS), bipolar junction transistors (BJT), high voltage transistors, high frequency transistors, P-channel and/or N-channel field effect transistors (PFETs/NFETs), FinFETs, planar MOS transistors with raised source/drains, nanosheet FETs, nanowire FETs, or the like.

Tiled MAC circuit 100 is shown as including at least one input buffer 104, multiple MAC tile circuits 102A-102C (sometimes referred to as “MAC tile circuit(s) 102” or “MAC tile(s) 102”). In some implementations, tiled MAC circuit 100 may include multiple input buffers 104, a global accumulation circuit 114, and an activation and pooling circuit 116. The input buffer 104 may include any number of memory elements, which may include dynamic random-access memory (DRAM) memory cells, static random-access memory (SRAM) cells, flash memory cells, eFuse memory cells, or any other type of memory cell capable of storing information electronically. As shown, the input buffer 104 can provide data to at least one MAC tile circuit 102A. The input buffer 104 may also receive data from, and be modified by, one or more activation and pooling circuits 116. The input buffer 104 can store, in one example, input data for one or more neural network layers of an artificial intelligence model.

The input buffer 104 can store information received from one or more external circuits, such as other memory circuits or processing circuits. The input buffer 104 can include memory elements that store binary information of any suitable format, including floating-point data of various precision, integer data of various precision, or other types of electronic information. One or more control circuits may communicate with the input buffer 104 to coordinate read operations (e.g., from one or more of the MAC tiles 102) and/or write operations (e.g., from the activation and pooling circuit 116).

Tiled MAC circuit 100 is shown, in this example, as including three MAC tile circuits 102. The MAC tile circuits 102 may sometimes be referred to herein as “processing elements.” Although this example diagram shows the three MAC tiles 102A, 102B, 102C, it should be understood that the MAC circuits described herein may include any number of MAC tiles 102. Each MAC tile circuit 102 can include a weight buffer 106, a MAC array 110, an input register 108, and an adder tree 112. The weight buffer 106 may include any number of memory elements, which may include dynamic random-access memory (DRAM) memory cells, static random access memory (SRAM) cells, flash memory cells, eFuse memory cells, or any other type of memory cell capable of storing information electronically. The memory elements of the weight buffer 106 may be modified by one or more control circuits that write and/or read data to the weight buffer 106. The weight buffer 106 can store weight values or other parameters of an artificial intelligence model. The weight buffer 106 can provide one or more of said parameters to the MAC array 110 for processing. In some implementations, the weight buffer 106 can store one or more portions of one or more convolutional filters, for use in convolution operations. The convolutional filters can be, in one example, 2D filters, 3D filters, or four-dimensional (4D) filters.

Each MAC tile 102 is shown as including a MAC array 110. The MAC array 110 can include one or more multiply-accumulate circuits. Each multiply-accumulate circuit in the MAC array 110 can include binary multiplication circuits and adder circuits. The multiplication circuits can be any suitable circuit that can perform binary multiplication on integer or floating-point values, or both, in some implementations. Multiplier circuits can multiply two values, such as a value of input data and a weight/parameter value of an artificial intelligence model, to generate a product. Products from multiple iterations and/or multiply circuits can be accumulated using the adder circuit(s) of the MAC array and/or the corresponding adder tree 112 of each MAC tile 102.

The adder circuits can be any suitable adder circuit that accumulates products generated by the multiplier circuits, any may include full adders and carry look-ahead circuits, or the like. Any suitable number of multiply-accumulate circuits may be included in the MAC array 110 to perform the various techniques described herein. In one example, a MAC array 110 can include at least three multiply-accumulate circuits, each of which can include three multipliers that multiply and accumulate weight values for a portion of a convolutional filter. In some implementations, the multiply-accumulate circuits can be arranged to generate products for weight values making up a portion of a convolutional filter, the resulting output values of which can be provided to the adder tree 112 of the MAC tile 102 to compute a partial sum for said portion the partial filter.

The adder tree 112 can be any type of addition circuit that can sum (e.g., accumulate) multiple values generated by the MAC array. In some implementations, the adder tree 112 can include multiple parallel adder trees, each of which can sum values from one or more sets of multiply-accumulate circuits of the MAC array 110. For example, each of the multiple adder trees 112 can sum values from a respective portion of a respective convolutional filter, in some implementations. The output of the adder tree 112 of each MAC tile 102 can be provide as output to the global accumulation circuit 114, as shown.

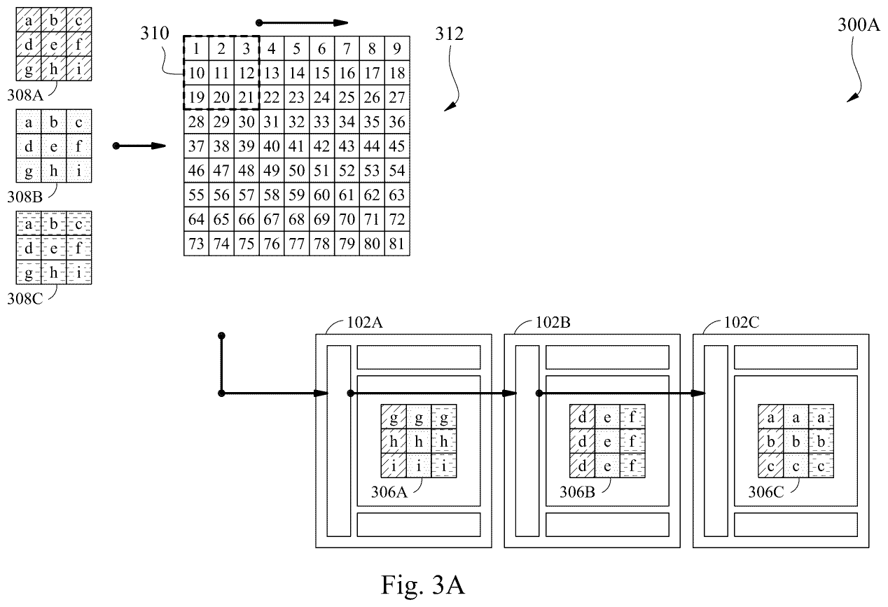

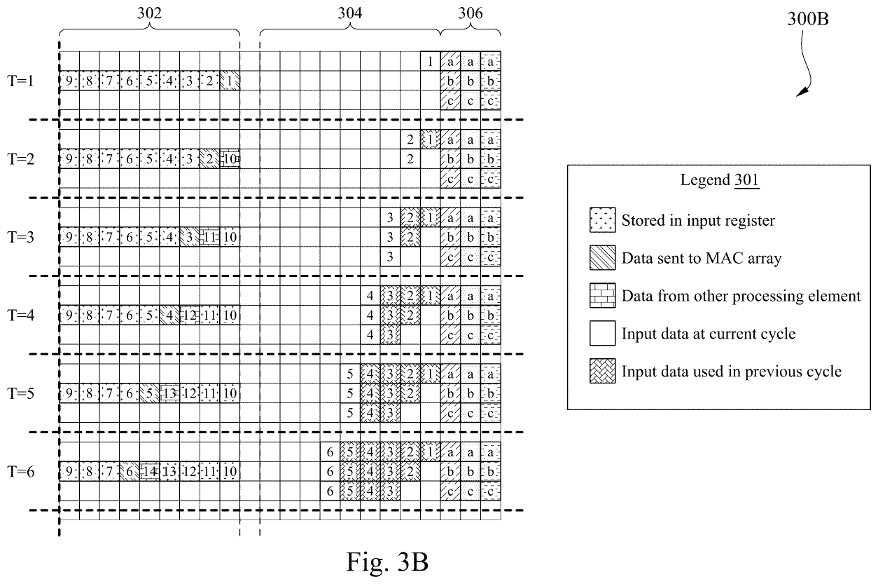

In some implementations, the adder tree 112 can include one or more registers or memory elements to store an output of the multiply-accumulate circuits of the MAC array 110 over multiple processing cycles. For example, the adder tree 112 can include one or more shift registers that receive an output of one or more of the multiply-accumulate circuits of the MAC array 110 to perform a convolution operation. The adder tree 112 can receive the outputs until a sufficient number of cycles have been calculated to generate the products required to generate a partial sum of the convolutional filter. For example, and as described in connection with FIGS. 3A and 3B, each MAC tile 102 can store weight data for at least one portion of a convolutional filter, in some implementations.

In some implementations, registers of each adder tree of each 112 of a MAC tile 102 can store the product outputs of the MAC array 110 until all weights have been used to generate products for one convolution operation using said portion of the convolutional filter weights. The adder tree 112 can sum the values of said products and provide the partial convolutional sum for that operation (e.g., corresponding to the respective weights maintained by said MAC tile 102) to the global accumulation circuit 114. Each MAC tile 102 can operate in parallel, such that each MAC generates a corresponding partial sum for the convolution iteration during the same cycle, in some implementations. In some implementations, the adder trees 112 of each tile can operate to implement multiple parallel filters that operate on the same input data, or 3D or 4D filters to implement 3D or 4D neural network architectures, in some implementations.

Each MAC tile 102 is shown as including an input register 108. The input register 108 can of the MAC tile 102A can receive data, such as input data for a neural network layer, from the input buffer 104. The input register 108 of the MAC tile 102 can both receive data from the input buffer and provide data to the input buffer of the next MAC tile 102 in the sequence, shown here as the MAC tile 102B. The input register 108 can store a set of input data that is to be processed by the corresponding MAC tile 102 to perform one or more convolution operations on the input data stored in the input buffer 104, in some implementations. The input register 108 can include circuitry to write to, and read from, one or more memory elements of the input register 108.

The input register 108 of the MAC tile 102B can receive input data from the input register 108 of the MAC tile 102A and provide said input data to the MAC array 110 of the MAC tile 102B and to the subsequent input register 108 of the next MAC tile 102, shown here as the MAC tile 102C. The input register 108 of the MAC tile 102C can receive said input data and provide the input data to the MAC array 110 of the MAC tile 102C for processing. Input data from the input buffer 104 can be propagated through the input buffers of each of the input registers 108 of the MAC tiles 102A-102C, such that each MAC tile 102A-102C stores and processes a portion of the input data that is to be processed according to the techniques described herein.

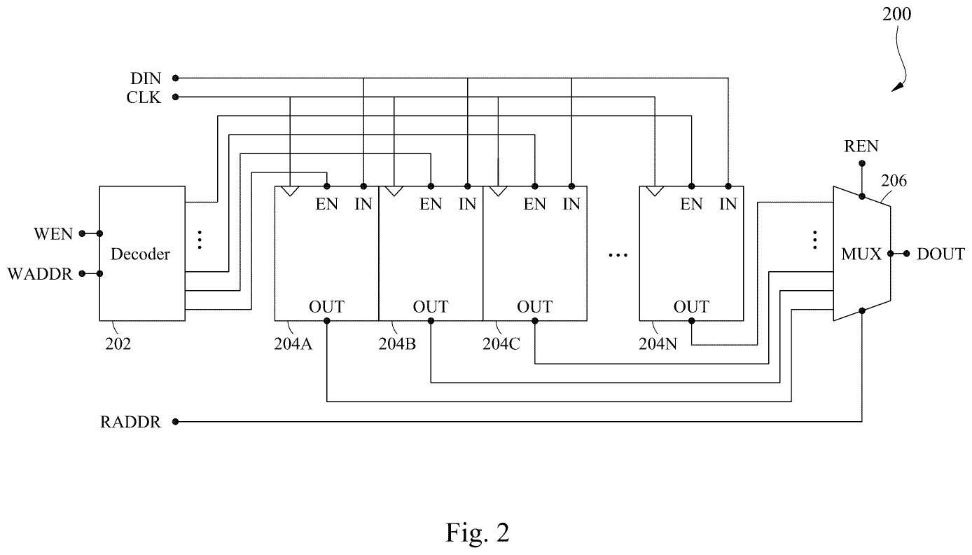

As input data is processed by the MAC tile 102A, said input data is propagated to the next MAC tile 102B during processing of the subsequent MAC operation. This pipeline parallelism reduces the overall time required to retrieve subsequent input data to process using the MAC tiles 102A-102C, reducing delays and improving processing performance per cycle. In some implementations, the input register 108 can provide multiple values stored by the input register 108 to subsequent input registers. Likewise, in some implementations, the input register 108 can receive multiple values from the input buffer 104 and/or input registers 108 of a preceding MAC tile circuit 102. Further details of the architecture of an example input register 108 are shown in FIG. 2. Although only three input registers 108 are shown in this example (of three MAC tiles 102), it should be understood that tiled MAC circuit 100 can include any number of MAC tiles 102, and therefore any number of input registers 108.

As shown, the output of the adder trees 112 are provided as input to the global accumulation circuit 114. The global accumulation circuit 114 can combine corresponding partial sums produced by each adder tree 112 for each convolution operation to produce an output for a processing cycle/iteration. For example, the adder trees 112 may each produce a partial sum for a convolution operation of a set of weight values (e.g., a filter, as described in connection with FIGS. 3A and 3B), which can be combined using one or more adder circuits included in the global accumulation circuit. When processing 3D or 4D convolutional operations, the global accumulation circuit 114 can further combine outputs of the adder trees 112 across one or more additional dimensions to produce an output for the iteration of the convolution operation. In some implementations, the global accumulation circuit 114 can provide multiple parallel outputs, for example, when performing a 2D convolution operation using multiple filters, as shown in FIGS. 3A and 3B, rather than combining said outputs using a single output value for the iteration of the convolution operation.

The outputs produced by the global accumulation circuit 114 can be provided as input to the activation and pooling circuit 116. The activation and pooling circuit 116 can be an electronic circuit that includes various logic gates, transistors, or other logical components or devices that can process received data according to an activation function and/or a pooling function. An activation function is a non-linear operation applied to each the outputs produced by the global accumulation circuit 114. Activation functions can be used to introduce non-linearity to data processed by the artificial intelligence model implemented by tiled MAC circuit 100.

Examples of activation functions that may be implemented by the components of the activation and pooling circuit 116 include a rectified linear unit (ReLU) activation function, a sigmoid activation function, a hyperbolic tangent activation function, a leaky ReLU activation function, or a softmax activation function, among others. The activation and pooling circuit 116 can also apply one or more pooling operations. The pooling operations may be performed on multiple convolutional outputs provided by the global accumulation circuit 114 and stored (e.g., temporarily) by the global accumulation circuit 114 and/or the activation and pooling circuit 116.

Pooling can be used to down-sample output values maps produced by the convolutional operations described herein for a single layer, reducing the spatial dimensions of the outputs in the aggregate while retaining information important for machine-learning operations. In some implementation, the activation and pooling circuit 116 can perform a max pooling operation, an average pooling operation, or a global pooling operation (e.g., a global average pooling operation, a global max pooling operation, etc.), among others. The output of the activation and pooling circuit 116 can, in some implementations, be stored in the input buffer 104 for further processing via the MAC tiles 102. For example, after processing one set of input data stored in the input buffer 104 to produce a set of output data, different weight values/parameters (e.g., for a subsequent neural network layer) can be retrieved and stored in the weight buffers 106 for each MAC tile 102. The output data in the input buffer 104 can then be used as input data for processing the weight/parameter values of the subsequent layer of the artificial intelligence model using the techniques described herein. This process may be repeated until an output of the artificial intelligence model is produced, in some implementations.

Referring to FIG. 2 in the context of the components described in connection with FIG. 1, illustrated is a block diagram of an example input register 200 included in a processing element of the tiled MAC circuit 100 of FIG. 1, in accordance with some embodiments of the present disclosure. The example input register 200 may be included, for example, as the input register 108 of a MAC tile 102 shown in tiled MAC circuit 100 of FIG. 1. In this example, the input register is shown as including a decoder 202, multiple memory elements 204A-204N (sometimes referred to as “register(s) 204”), and a multiplexer 206.

The input register 200 may include one or more logic gates and sub-circuits, each of which may be constructed from one or more logic gates. Logic gates are electronic devices that perform logical operations on one or more input signals to produce a single output signal. Various embodiments of the circuits and logic gates that implement the input register 200 may include various transistors. The transistors described herein may have a certain type (n-type or p-type), but embodiments are not limited thereto. The transistors can be any suitable type of transistor including, but not limited to, MOSFET, CMOS transistors, PMOS, NMOS, BJT, high voltage transistors, high frequency transistors, PFETs/NFETs, FinFETs, planar MOS transistors with raised source/drains, nanosheet FETs, nanowire FETs, or the like.

To write to the input register, the data input DIN is provided with a corresponding written enable signal WEN and a write address WADDR. The DIN data can be binary data representing a number (e.g., one or more values to be processed by the MAC array 110) to be stored into a memory element 204 identified by the write address WADDR. The decoder 202 can receive the write address WADDR and the write enable signal WEN, and generate a corresponding enable signal (having an appropriate logical state) to activate the memory element 204 for writing at the next clock cycle, while deactivating the enable signal for each other memory element 204 in the input register 200.

Each of the memory elements 204 of the input register 200 can include one or more sets of flip-flips or latches that can store binary data (e.g., a floating-point number, a set of floating-point numbers, an integer number, a set of integer numbers, etc.). As shown, each memory element 204 receives an enable signal EN, an input signal IN, and provides an output signal OUT. When the enable signal EN is activated (e.g., via a corresponding logic low or logic high signal), the data provided on the input signal IN is written to the memory elements (e.g., flip-flops, latches, etc.) of the corresponding memory element 204. When the enable signal of the memory element 204 is deactivated, the register maintains its value(s) in its memory element without overwriting said data with information present on the input signal IN.

The input register 200 can receive an input clock signal CLK. The input clock signal CLK can alternate between logic states over time, causing the state of the each of the memory elements 204 to change subject to their respective enable signal. The clock signal CLK can be generated, for example, using a clock generation circuit, which may provide said clock signal to other circuits in communication with, or related to, the input register 200 (e.g., the MAC tiles 102, etc.). The input register 200 can update its memory elements on a rising edge and/or falling edge of the clock signal CLK, in some implementations.

Each memory element 204 can provide the data stored in its memory element(s) via its corresponding output signal OUT. As information in the memory elements 204 is updated, the data on the output signal OUT changes to reflect the information received via the data input signal DIN. In this configuration, each of the memory elements 204 in the input register 200 can be written to and read from independently, enabling various techniques described herein. As shown, the output signal OUT of each memory element 204 is provided as input to the multiplexer 206.

The multiplexer 206 receives, as input, the output signals of each memory element 204 of the input register 200. The multiplexer 206 also receives a read enable signal REN and a read address signal RADDR. The read address signal RADDR identifies the memory element 204 whose output signal OUT is to be provided as the data output signal DOUT of the input register 200. The data output signal DOUT can be provided, in some implementations, to an input of a MAC array 110 described in connection with FIG. 1, or to as an input signal DIN of a subsequent input register 200 of a subsequent MAC tile 102 of FIG. 1. The read enable signal REN, when activated (e.g., in a corresponding logic state) can cause the multiplexer to provide the data selected via the read address signal RADDR as the data output DOUT. When the read enable signal REN is deactivated, the multiplexer 206 may provide default or undefined output on the data output DOUT.

Although each memory element 204 is represented here as being a single flip-flop, it should be understood that each memory element 204 and the multiplexer 206 can receive, store, and provide information having any bit-width. For example, each memory element 204 and the multiplexer 206 can receive, store, and provide any number of floating-point or integer values and/or integer values for processing according to the techniques described herein. Likewise, although shown as single elements, it should be understood that various circuit elements shown in the block diagram of FIG. 2 may have parallel/duplicate counterparts to perform the techniques described herein.

Referring to FIGS. 3A and 3B, illustrated are dataflow diagrams 300A and 300B, respectively, illustrating how information is processed and propagated through the tiled MAC circuit architectures described herein, in accordance with some embodiments of the present disclosure. FIG. 3A shows the dataflow diagram 300A, showing how input data 312 (represented by a numerical grid) is processed using three example MAC tiles 102A, 102B, and 102C in a convolution operation using three convolutional filters 308A, 308B, and 308C (sometimes generally referred to as “filter(s) 308”).

In this example a convolutional operation, each filter 308 can include a corresponding set of weight values, designated as the letters a-i, in this example. The filters 308 may have any dimension and any number of weight values, although in this example the filters 308 are shown as including nine weight values in a 3×3 configuration. To perform a convolution operation, each filter 308 is applied to the input data at a sliding window position 310. Furthering this example, at the position 310, the weight value “a” would be multiplied by the input data value “1”, the weight value “b” would be multiplied by the input data value “2”, the weight value “d” would be multiplied by the input data value 10, and so on. The results of these multiplications (e.g., the products) are summed to form a convolution output for that position. Each convolutional filter is then shifted to the right to perform the convolution operation for the next position, until all convolutional outputs have been generated using the filter(s) 308.

The computational efficiency of this process is improved by reusing the data across the MAC tiles 102, as shown. To do so, and as described in further detail herein, each MAC tile 102 can store a corresponding portion of the filters 308A, 308B, and 308C. In this example, the MAC tile 102C stores the weight values “a”, “b”, and “c” of the filters 308A-308C, the MAC tile 102B stores the weight values “d”, “e”, and “f” of the filters 308A-308C, and the MAC tile 102A stores the weight values “g”, “h”, and “i” of the filters 308A-308C. In some implementations, each of the MAC tiles 102 can store a single row of each filter 308, regardless of the dimension, to carry out the calculations described herein.

Although the weight designators “a” through “i” are shown for the filters 308A-308C, it should be understood the weight values each position designated by the letters a-i are different for different filters. For example, the weight designated by “a” in the filter 308A can be different than the weight designated by “a” in the filter 308B, and so on. As shown, the input data can be accessed by the first MAC tile 102A and propagated through the second MAC tile 102B and the MAC tile 102C to store a corresponding set of input data in the input register 108 of each MAC tile 102, as shown in FIG. 1. An example dataflow diagram showing how data is processed using a MAC tile 102 is shown in FIG. 3B.

Referring to FIG. 3B in the context of the components described in connection with FIGS. 1 and 3A, illustrated is a dataflow diagram 300B showing how the MAC tile 102C (as shown in FIG. 3B) processes the first portions of input data 312 stored in its input register 302 across multiple timesteps (designated by T=1, T=2, etc.). The status of each data value is designated in FIG. 3B according to the shading shown in the legend 301. In this example convolution operation, at time T=1, the input register 302 of the MAC tile 102C has stored the input data 312 values 1 through 9, which may be propagated through MAC tiles 102A and 102B and received from MAC tile 102B.

Data items that are provided to or previously processed by the MAC array are shown in the region 304. At each time period (e.g., T=1, T=2, etc.) the left-most data value(s) are those being processed by the MAC array during the corresponding time period. Any additional data value(s) to the right of the left-most value(s), if any, are shown as those that were previously processed by the MAC array for reference, and do not necessarily indicate that these values are stored by any registers or other memory elements in the MAC tile 102.

In some implementations, the input register 302 of each MAC tile can store at least a single row of the input data 312 shown in FIG. 3A. In this example, each row includes nine data values (e.g., the values “1” through “9”in the top row, the values “10” through “19”, etc.). It should be understood that the data values “1”, “2”, “3”, and so on referred to here are designators for electronic information stored as part of the input data 312, and do not necessarily refer to the actual numerical value of said data value. Each data value may be or include any datatype or data structure, including floating-point data, integer data, binary data, or combinations thereof. As shown, at the time period T=1, once the input data has been loaded into the input register 302, the input data 312 value “1” has been provided to the MAC array for processing, which calculates a respective product by multiplying the value “1” by the weight values “a” of the three example filters stored in the MAC array (e.g., stored in or received from the weight buffer 106 shown in FIG. 1).

At the time T=1, although not shown here, the MAC tiles 102A and 102B also store and process corresponding input data in their respective input registers. For example, the MAC tile 102B can store the input data 312 values “10” through “18”, and the MAC tile 102A can store the input data 312 values “19” through “27”. In this example, he first data value in each input register (e.g., “10” for the MAC tile 102B and “19” for the MAC tile 102A) can be processed by providing said value as input to the MAC array of the corresponding MAC tile 102. During the same clock cycle or in one or more subsequent clock cycle, the processed data item can be provided to, and written to the same position in the input register 302 of, the next MAC tile 102. The input value “1” is only multiplied by the weight value “a” of each filter and not multiplied by the weight values “b” and “c” because, as shown according to the sliding window position 310 of FIG. 3A, the convolution operation does not include multiplying the value “1” by the weight values “b” and “c” of any filter, even when shifted according to the convolutional pattern.

As shown, at time T=2, the value in the first position of the input register 302 has been overwritten by the input data value “10”, which previously processed by, and received from, the

MAC tile 102B in this example. Although not shown here, a similar write operation has occurred at the MAC tile 102B of FIG. 3A, such that the input data value “19” has overwritten the input data value “10” in its input register. In FIG. 3A, the MAC tile 102A does not have a prior MAC tile from which to receive data values. As such, the MAC tile 102A retrieves the next data value from the next row of the input data 312, which in this example is the data value “28” and overwrites the value “19” in its input register. As shown in FIG. 3B, while the input data value “1” is overwritten, the next value in the input register 302 is provided as input to the MAC array 110 of the MAC tile 102A. Note that because the input value “2” is multiplied by the both the weight values “a” and “b” of the three filters, because the convolutional shifting causes two the convolutional filters to overlap with the data value “2” at two different positions.

This process continues for each data value in the input register 302, with the input register 302 continuously being updated with a corresponding value of the neighboring MAC tile 102. As shown in the region 304, at T=3, the input data value “3” is processed by the weight values “a”, “b”, and “c”, in accordance with the convolutional operation described in connection with FIG. 3A, and the input register 302 is updated to include the data value “11”, as shown. This process repeats for each time period T=4, T=5, and T=6, with the data values “4”, “5” and “6” being processed, and the input register 302 being updated with the values “12”, “13”, and “14”, as shown.

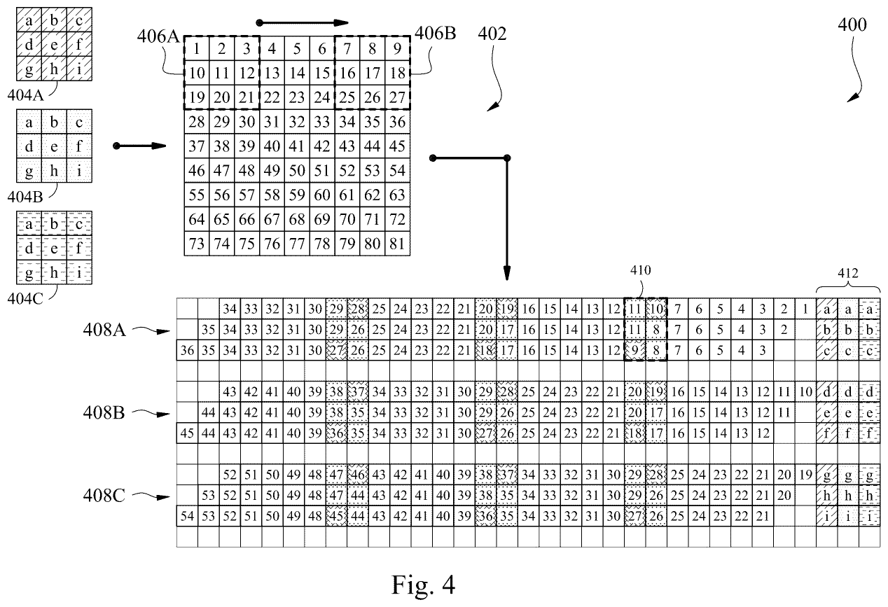

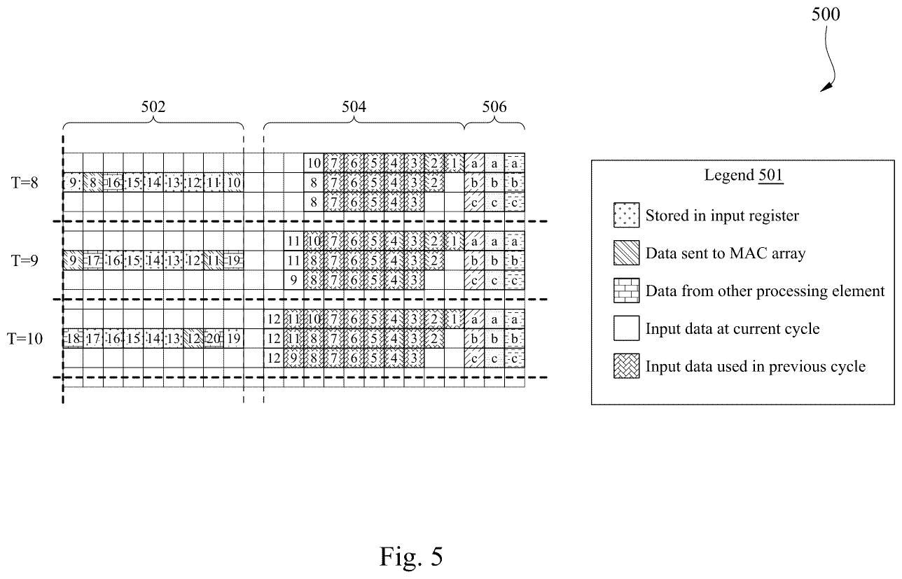

At subsequent timesteps that, in this example, process the last two data values “8” and “9”, the data value “8” can be provided only to the weight values “b” and “c”, and the data value “9” can be provided only to the weight value “c”. This occurs because the convolutional filter, after the right-most weight (e.g., “c”, “f”, “i”) is applied to the right-most set of data values (e.g., “9”,” “18”, “27”), is shifted one row downward and returns to its starting left-most position shown in FIG. 3A. As such, the weight “a” is not applied to the data value “8” or “9”, and the weight value “b” is not applied to the data value “9”. Furthering this example, the next data to be processed for the next row the weight value “a” is “10”, which is at this time period is already stored at the starting position of the input register 302 shown in FIG. 3B. This enables all MAC tiles 102 to immediately begin processing the next row, without requiring costly memory retrieval operations to continue processing. FIGS. 4 and 5 provide an alternative storage and processing approach for input data 312 at the “edges” of a convolutional operation.

Referring to FIG.4 in the context of the components described in connection with FIG. 1, 3A, and 3B, illustrated is a block diagram 400 illustrating how data is arranged to process certain convolution operations using the tiled MAC circuit architectures described herein, in accordance with some embodiments of the present disclosure. As described above, during a convolutional operation, as the filters have processed all data in a row (or set of rows, as described herein), certain data values are not processed by all weights of the convolutional filter. The datasets 408A, 408B, and 408C show how data values can be stored to leverage overlapping data stored within the same input register. As shown, the convolutional filters 404A, 404B, and 404C (sometimes referred to as the “filter(s) 404” are similar to the convolutional filters 308A, 308B, and 308C of FIG. 3A. Likewise, the input data 402 is similar to the input data 312 of FIG. 3A.

As shown, during the convolution operation, the filters 404 begin at sliding window position 406A and iteratively process data, eventually moving to the last position in the top portion of the input data at the sliding window position 406B. As described herein, the convolution operation results in the right-most column of the input data 402 only being processed (e.g., multiplied) by the weight values in the right-most column of the filters (e.g., designated by “c”, “f”, and “i”). Likewise, the second right-most column of the input data 402 is only processed by the weight values in the right-most column of the filters (e.g., designated by “b”, “e”, “h”, “c”, “f”, and “i”). Additionally, the left-most column of the input data is only processed by the weight values in the left-most column of the filters (e.g., designated by “a”, “b”, and “c”). Likewise, the second left-most column of the input data 402 is only processed by the weight values in the right-most column of the filters (e.g., designated by “a”, “b”, “c”, “d”, “e”, and “f”).

Data processed by the weight MAC tiles can be provided to the weight values 412 as shown in the portion 410, such that the data values of a row of input data 402 that are processed by a single weight value are processed at the same time as data values of a second row of input data 402 that are processed only by two weight values. As shown in the portion 410, the data value “10”, in the dataset 408A that is processed by the MAC tile 102C, is only processed using only the weight value “a”, and is processed simultaneously with the data value “8”, which is only processed using the weight values “b” and “c” of each filter.

This storage/retrieval scheme is used for each transition between rows in the convolution operation, as shown, for each data element. Although the datasets 408A, 408B, and 408C are shown as separate datasets, it should be understood that this presentation is for clarity purposes only, and that the datasets 408A, 408B, and 408C using the data sharing and pipeline parallelism techniques described herein to improve overall data throughput. Examples showing how the datasets are processed by a MAC tile 102 are shown in FIG. 5.

Referring to FIG. 5 in the context of the components described in connection with FIGS. 1, 3A, 3B, and 4, illustrated is a dataflow diagram 500 illustrating how information stored according to the arrangement shown in FIG. 4 is processed and propagated through the tiled MAC circuit architectures described herein, in accordance with some embodiments of the present disclosure. As shown, the input register 502, the region 504, and the weight values 506 are similar to the input register 302, the region 304, and the weight values 306 described in connection with FIG. 3B. The status of each data value is designated in FIG. 5 according to the shading shown in the legend 301.

The example shown in the diagram 500 begins at time period T=8, following the time period T=6 shown in FIG. 3B, using the alternative data sharing scheme shown in FIG. 4. As shown, at time period T=8, the input data value “7” has been overwritten with the input data value “16” received from the input register of the preceding MAC tile circuit 102A, according to the techniques described herein. To implement the data processing scheme shown in the portion 410 of FIG. 4, the input register 502 can provide two data values as input to the MAC array 110 of the corresponding MAC tile. In this example, the data value “8” is provided in connection with the weight values “b” and “c”, and the data value “10” is provided in connection with the weight value “a”. In such implementations, the input register of the MAC tile 102 can include additional read circuitry to read provide output values.

In a subsequent time period T=9, the data value “8” is overwritten by the data value “17”, data “10” is overwritten by 19,” and both the data values “9” and “11” are provided as input to the MAC array. In this example, the data value “11” is provided in connection with the weight values “b” and “c”, and the data value “9” is provided in connection with the weight value “a”. During the next time period T=10, and processing of the next row of the input data 402 for the convolution operation, the data value “9” is overwritten with the data value “18,” data “11” is overwritten by “20,” and the data value “12” is provided to each of the weight values “a”, “b”, and “c”, consistent with the datasets 408 shown in FIG. 4.

Although the approaches shown in FIGS. 3A, 3B, and 5 described MAC tiles 102 that process rows of input data including nine data values using three 3×3 convolutional filters, it should be understood that the MAC tiles described herein can be implemented to process input data and weight values having any dimension. For example, other numbers and sizes of convolutional filters may be utilized, including 1×1 filters, 5×5 filters, 7×7 filters, 9×9 filters, 11×11 filters, including 3D filters, 4D filters, or filters having higher dimensionality. Likewise, the input data processed by the MAC tiles described herein can have any size and dimensionality, including 3D input data, 4D input data, or input data having higher dimensionality.

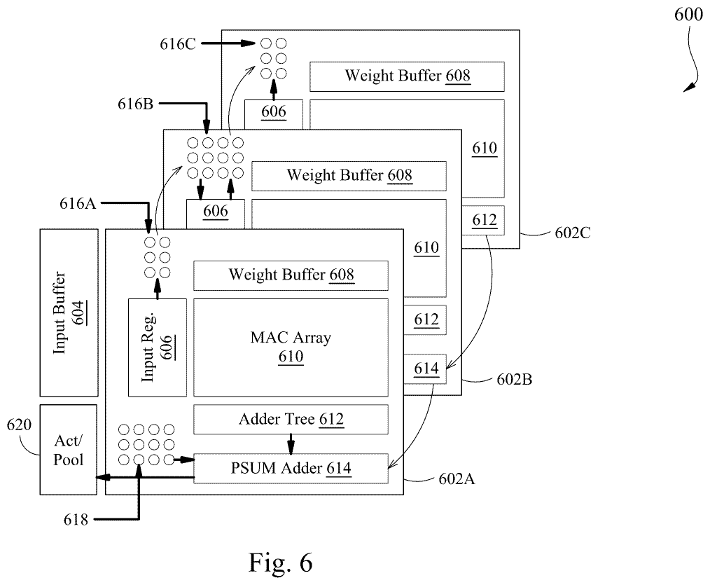

The foregoing approaches may be implemented using the 2D tile configuration shown in FIG. 1, for example. In addition to a 2D tile configuration, in which all files are defined on the same semiconductor layer(s), the techniques described herein may also be implemented using 3D semiconductor techniques. In an implementation provided using a 3D semiconductor technique, each MAC tile can be implemented on a separate semiconductor layer, and data can be transmitted between tiles using corresponding vias. An example diagram showing an example implementation of tiled MAC circuits implemented using 3D semiconductor techniques is described herein in connection with FIG. 6.

Referring to FIG. 6, illustrated is a block diagram of an example three-dimensional (3D) tiled MAC circuit 600 implemented to accelerate artificial intelligence operations, in accordance with some embodiments of the present disclosure. The tiled MAC circuit 600 shown in FIG. 6 can be used to implement any artificial intelligence operation involving a MAC operation. For example, the tiled MAC circuit 600 can be used to perform convolution operations (e.g., for one layer of a convolutional neural network, etc.). In some implementations, and as shown in this example, the tiled MAC circuit 600 can include an input buffer 604 and an activation and pooling circuit 620, which may be similar to, and include any of the structure and functionality of, the input buffer 104 and the activation and pooling circuit 116 described in connection with FIG. 1.

The tiled MAC circuit 600 may include one or more logic gates and sub-circuits, each of which may be constructed from one or more logic gates. Logic gates are electronic devices that perform logical operations on one or more input signals to produce a single output signal. Various embodiments of the circuits and logic gates that implement the tiled MAC circuit 600 may include various transistors. The transistors described herein may have a certain type (n-type or p-type), but embodiments are not limited thereto. The transistors can be any suitable type of transistor including, but not limited to, MOSFET, CMOS transistors, PMOS, NMOS, BJT, high voltage transistors, high frequency transistors, PFETs/NFETs, FinFETs, planar MOS transistors with raised source/drains, nanosheet FETs, nanowire FETs, or the like.

As shown, the tiled MAC circuit 600 is shown, in this example, as including three MAC tile circuits 602A, 602B, and 602C (sometimes referred to herein as “MAC tile circuit(s) 602” or “MAC tile(s) 602”). The MAC tile circuits 602 may sometimes be referred to herein as “processing elements.” Although this example diagram shows the three MAC tiles 602A, 602B, 602C, it should be understood that the MAC circuits described herein may include any number of MAC tiles 602. Each MAC tile circuit 602 can include any of the structure, and perform any of the functionality of, the MAC tile circuits 102 of FIG. 1.

Each MAC tile circuit 602 can include a weight buffer 608, which may be similar to and include any of the structure/functionality of the weight buffer 106 of FIG. 1. Each MAC tile circuit 602 can include a MAC array 610, which may include any of the structure/functionality of the MAC array 110 of FIG. 1. Each MAC tile circuit 602 can include an input register 606, which may include any of the structure/functionality of the input register 108 of FIG. 1 and/or the input register 200 of FIG. 2. Each MAC tile circuit 602 can include an adder tree 612, which may include any of the structure/functionality of the adder tree 112 of FIG. 1.

The MAC tile circuits 602A, 602B, and 602C can include input register vias 616A, 616B, and 616C (sometimes referred to as “input register via(s) 616”), respectively, that enable transmission between the input registers 606 of adjacent MAC tile circuits. The input register via(s) 616 of adjacent tiles can enable transmission of input data values between input registers, for example, to overwrite data stored in the input registers 606 as described in connection with FIG. 3B, or to initialize the input registers 606 with input data to perform artificial intelligence operations. The input register vias 616 can be defined in each layer of semiconductor substrate that includes the MAC tiles 602. Electrical interconnects can communicatively couple one or more of the input register vias 616 to corresponding circuit components of the input registers 606 to perform the various operations described herein. Each MAC tile circuit 602 can include any number of input register vias 616 suitable to transmit information according to the techniques described herein.

Rather including a global accumulation circuit 114, at least one of the MAC tiles 602 can include a partial sum adder circuit 614. In implementations with more than two MAC tile circuits 602, as shown, each MAC tile circuit 602 except for the bottom-most (or top-most, in some implementations) MAC tile circuit 602 can include a partial sum adder circuit 614. The partial sum adder circuit 614 can receive received sum data from the adder tree 612 of the corresponding MAC tile 602, and partial sum data from an adjacent tile via a set of adder vias 618.

Each of the MAC tile circuits 602 can include a set of adder vias 618, which can enable transmission between the adder tree 112 and/or the partial sum adder 114 of adjacent MAC tile circuits. Although only one set of adder vias 618 are shown here, it should be understood that each of the MAC tile circuits 602A, 602B, and 602C can include a corresponding set of the adder vias 618 to facilitate adding partial sums for artificial intelligence operations, as described herein. The adder vias 618 of adjacent tiles can enable transmission of partial sums produced by the adder trees 612 (e.g., for the bottom-most MAC tile 602, in this example the MAC tile 602C) or the partial sum adder circuit 614 (e.g., for any MAC tile 602 except the bottom-most MAC tile 602).

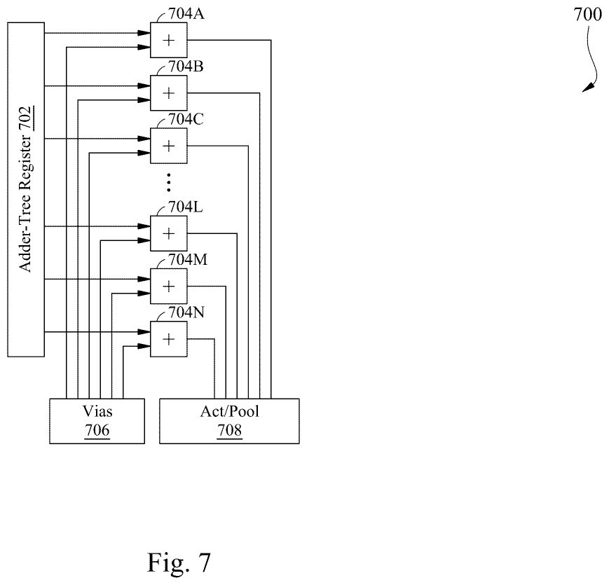

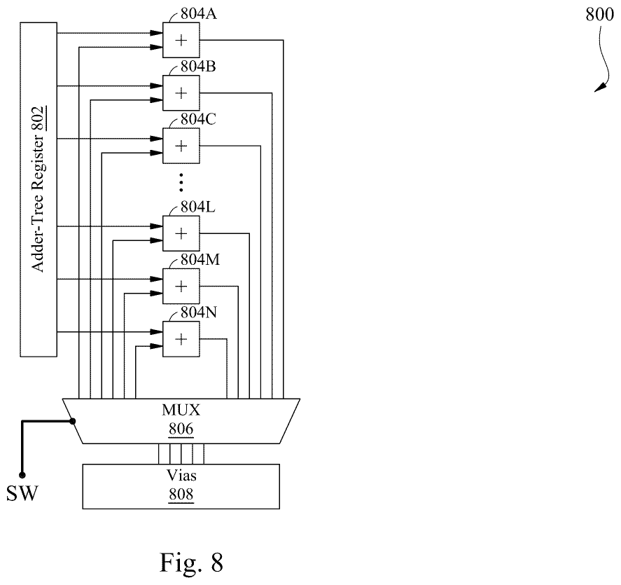

As shown, partial sum data generated at a MAC tile 602 propagated through the adder vias 618 to the next adjacent MAC tile 602. At said adjacent MAC tile 602, the partial sum data received from the adder vias 618 is combined with the output of the adder tree 612 by the partial sum adder circuit 614. The partial sum adder circuit 614 can include any number of adder circuits, including full adders and carry lookahead circuits, in some implementations. The partial sum adder circuit 614 of the MAC tile circuit 602B can provide the resulting sum to another set of adder vias 618 to propagate the partial sum to the MAC tile circuit 602A. The partial sum adder circuit 614 of the MAC tile circuit 602A can combine the input from the adder vias 618 and the corresponding adder tree 612 to generate the output of the convolution operation and provide the resulting output sum to the activation and pooling circuit 620. Further details of the operation of the partial sum adder circuit 614 are described in connection with FIGS. 7 and 8.

Referring to FIG. 7 in the context of the components described in connection with FIG. 6, illustrated is a block diagram of an example partial sum adder circuit 700 implemented as part of a tier of the 3D tiled MAC architecture shown in FIG. 6, in accordance with some embodiments of the present disclosure. The partial sum adder circuit 700 may include one or more logic gates and sub-circuits, each of which may be constructed from one or more logic gates. Logic gates are electronic devices that perform logical operations on one or more input signals to produce a single output signal. Various embodiments of the circuits and logic gates that implement the partial sum adder circuit 700 may include various transistors. The transistors described herein may have a certain type (n-type or p-type), but embodiments are not limited thereto. The transistors can be any suitable type of transistor including, but not limited to, MOSFET, CMOS transistors, PMOS, NMOS, BJT, high voltage transistors, high frequency transistors, PFETs/NFETs, FinFETs, planar MOS transistors with raised source/drains, nanosheet FETs, nanowire FETs, or the like.

The partial sum adder circuit 700 shown in this example can be implemented as the partial sum adder circuit 614 of the top-most MAC tile circuit 602A of FIG. 6. As shown, the partial sum adder circuit 700 includes an adder tree register 702, a set of adder circuits 704A-704N (sometimes referred to as “adder circuit(s) 704”), a set of vias 706, and an activation and pooling circuit 708. The vias 706 may be similar to, and include any of the structure or functionality of, the adder vias 618 of FIG. 6, and the activation and pooling circuit 708 may be similar to, and include any of the structure or functionality of, the activation and pooling circuit 620 of FIG. 6. The adder tree register 702 can include one or more memory elements, such as flip-flops, latches, SRAM cells, DRAM cells, or other types of memory elements that store the output of the adder circuit 612 of the corresponding MAC tile 602 (e.g., the MAC tile 602A). As shown, the adder tree register 702 and the vias 706 can provide respective data to the adder circuits 704.

Each adder circuit 704 can compute the sum between the two input values and provide the resulting output value to the activation and pooling circuit 708. The adder circuits 704 can be any type of adder circuit, such as full adder circuit. Any number of adder circuits 704 may be included in the partial sum adder circuit 700. In some implementations, the adder circuits 704 can include one or more adder trees. The adder circuits 704 can sum data having any bit-width or data type, including floating-point values or integer values having any precision/bit-width, in some implementations. An implementation showing a partial sum adder that can provide a partial sum to the partial sum adder circuit 700 using the vias 706 is shown in FIG. 8.

Referring to FIG. 8 in the context of the components described in connection with FIG. 6, illustrated is a block diagram of another example partial sum adder circuit 800 implemented as part of a tier of the 3D tiled MAC architecture shown in FIG. 6, in accordance with some embodiments of the present disclosure. The partial sum adder circuit 800 may include one or more logic gates and sub-circuits, each of which may be constructed from one or more logic gates. Logic gates are electronic devices that perform logical operations on one or more input signals to produce a single output signal. Various embodiments of the circuits and logic gates that implement the partial sum adder circuit 800 may include various transistors. The transistors described herein may have a certain type (n-type or p-type), but embodiments are not limited thereto. The transistors can be any suitable type of transistor including, but not limited to, MOSFET, CMOS transistors, PMOS, NMOS, BJT, high voltage transistors, high frequency transistors, PFETs/NFETs, FinFETs, planar MOS transistors with raised source/drains, nanosheet FETs, nanowire FETs, or the like.

The example partial sum adder circuit 800 can be provided on any intermediate (e.g., the middle, MAC tile 602B) MAC tiles 602 of the 3D tiled MAC circuit 600. As shown, the partial sum adder circuit 800 includes the adder tree register 802, which can be similar to and include any of the structure and functionality of the adder tree register 702. The partial sum adder circuit 800 is shown as including adder circuits 804A-804N (sometimes referred to as “adder circuit(s) 804”), which can be similar to and include any of the structure and functionality of the adder circuits 704A-704N. Any number of adder circuits 804 may be included in the partial sum adder circuit 800.

The partial sum adder circuit 800 is shown as including a multiplexer 806 and a set of vias 808. A subset of the set of vias 808 can receive input from an adjacent MAC tile 602, and a second subset of the set of vias 808 can provide the output of the adder circuits 808N. The multiplexer can include transistors, logic gates, or other logical components to switch between receiving input from the vias 808 and providing output data through the vias 808. One or more control circuits can activate or deactivate the switch signal SW to control the input/output of the multiplexer 806. Prior to the summing operation, the switch signal SW can cause the multiplexer 806 to provide received partial sum data to as input to the adder circuit 804. In addition, the adder tree register 802 can provide partial sum data (e.g., from the MAC array 610) as the second operand to each of the adder circuits 804 to generate an output sum.

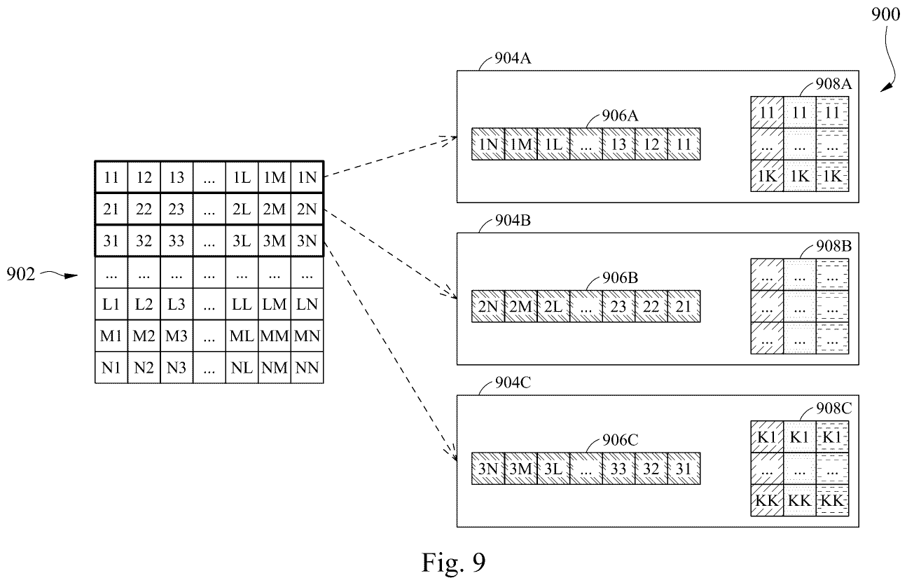

The output sum generated by the adder circuits 804 can be stored or otherwise buffered in one or more registers of the adder circuits 804. Once the output sum is generated, one or more control circuits can cause the switch signal SW to change, such that the output of the adder circuits 804 are provided to a corresponding set of the vias 808. This enables the output partial sum data (e.g., for a convolution operation) to be provided to the next adjacent MAC tile (e.g., the MAC tile 602A of FIG. 6). Example dataflow diagrams showing how data is exchanged between MAC tiles 602 in a 3D configuration are described in connection with FIGS. 9-12.

Referring to FIGS. 9, 10, 11, and 12 in the context of the components described in connection with FIG. 6, illustrated are dataflow diagrams 900, 1000, 1100, and 1200 showing steps for data processing operations using the 3D tiled MAC circuit shown in FIG. 6, in accordance with some embodiments of the present disclosure. In FIG. 9, the diagram 900 shows a set of input data 902, which can be similar to the set of input data 312 of FIG. 3A or the set of input data 402 of FIG. 4. The diagram 900 includes the MAC tiles 904A, 904B, and 904C (sometimes referred to as “MAC tile(s) 904”), which respectively correspond to the MAC tiles 602C, 602B, and 602A of FIG. 6.

In this example, data processed or stored by a MAC tile 904 is shown as included within the respective MAC tile 904. As shown, the MAC tiles 904A, 904B, and 904C include the input registers 906A, 906B, and 906C (sometimes referred to as “input register(s) 906”), respectively. The input registers 906 can be, for example, the input registers 606 of FIG. 6, and are represented in a manner similar to the input registers 302 of FIG. 3B. The MAC tiles 904A, 904B, and 904C include the weight values 908A, 908B, and 908C (sometimes referred to as “weight value(s) 908”), respectively. The weight values 908 can be similar to the weight values 306 of FIG. 3B. As shown, the weight values 908 include values for three convolutional filters, each having K rows and K columns.

In this example, data value representations of the input data 902 are shown as values such as “11”, “12”, and so on, with the first number representing the row of the input data 402 at which the corresponding data value is stored, and the second number representing the column of the input data 402 at which the corresponding data value is stored. Similar designations are utilized to identify the weight values, as described herein. Ellipses are utilized to indicate that the number of columns and rows in the set of weight values for the three convolutional filters are arbitrary.

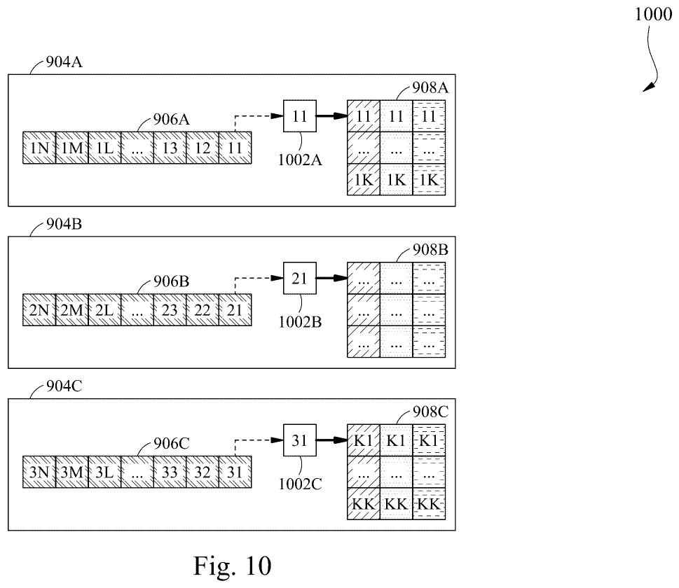

As shown, to perform a convolution operation, the first three rows of the input data 902 are stored in the input registers 906 of the MAC tiles 904. Data can be preloaded into the registers by propagating the data through each of the input registers 906, as described herein. Once preloaded, in FIG. 10, the diagram 1000 shows the input data values 1002A, 1002B, and 1002C of the input registers 906A, 906B, 906C being provided to the MAC array storing or otherwise receiving the weight values 908A, 908B, and 908C. In this example, the first item of input data values 1002A, 1002B, and 1002C is applied to the first row of the three weight column vectors of the weight values 908.

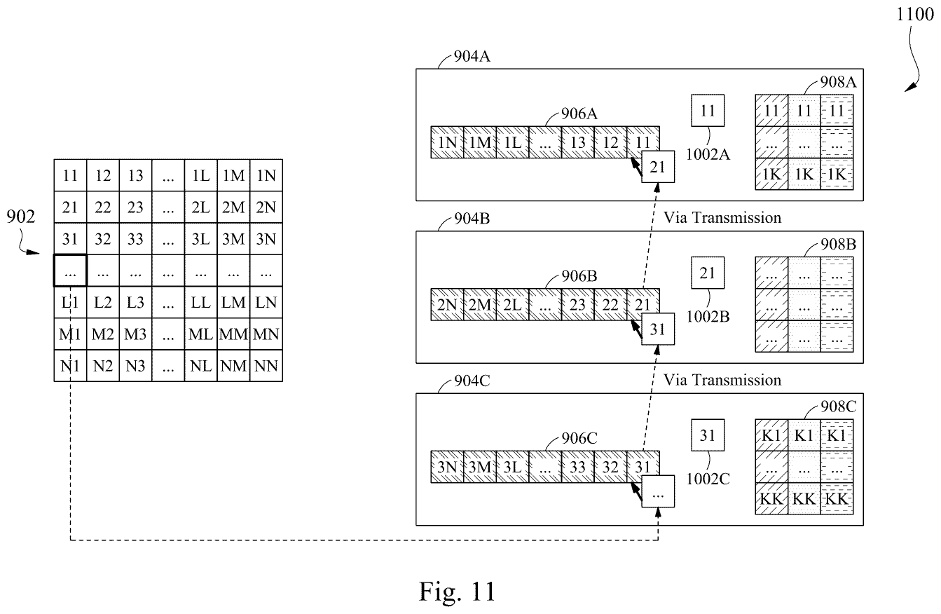

Once applied, in FIG. 11, the diagram 1100 shows that the data value 1102 in the first column of the next row of the input data 902 is retrieved and provided to the first position of the input register 906C, using techniques similar to those described in connection with FIG. 3B. The value previously stored in the first position of the input register 906C (in this example, the data value designated as “31”) is transmitted using the input register vias 616 to the input register 906B. Said data value is stored in the first position of the input register 906B. The value previously stored in the first position of the input register 906B (in this example, the data value designated as “21”) is transmitted using the input register vias 616 to the input register 906A. Said data value is written to, and overwrites, the data value designated as “11” in the first position of the input register 906. The next input data values for each input register 906 (in this example, “12”, “22”, and “32”) are then provided to the corresponding sets of weight values 908, as described herein.

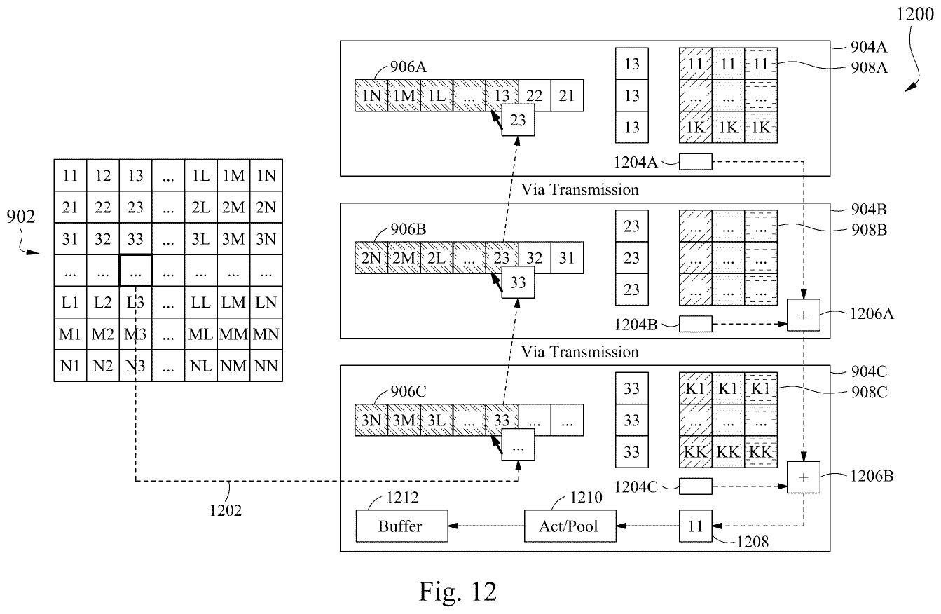

In FIG. 12, the diagram 1200 shows an updated iteration of the diagram 1100 after the same operation described in connection with FIG. 11 has been repeated. As shown in the diagram 1200, the second position in each input register 906 has been updated using the data in the second column of the next row of the input data 902. The data values “13”, “23”, and “33” from the third position of the input registers 906A, 906B, and 906C are applied to the weight values 908A, 908B, and 908C. The resulting output sums 1204A, 1204B, and 1204C (e.g., computed by the adder tree 612, etc.) are provided to the partial sum adder circuits 1206A and 1206B, which may be similar to the partial sum adder circuits 614 of FIG. 6.

As shown, the output sum of the partial sum adder circuit 1206A is provided as input to the partial sum adder circuit 1206B (e.g., using the adder vias 618, as described herein), with the output data 1204C, generating the output data value 1208 for the iteration of the convolution operation (e.g., a convolution operation at a single window position, etc.). The output data value 1208 is provided as input to the activation and pooling circuit 1210, which can be similar to the activation and pooling circuit 620. The activation and pooling circuit 1210 can provide an output (e.g., upon applying an activation function or pooling function, etc.) to the buffer 1212 for storage. The buffer 1212 can be, for example, the input buffer 604, an output buffer/memory circuit, or another memory element.

As the output data value 1208 is generated, the data value 1202 in the third column of the next row of the input data 902 is retrieved and provided to the third position of the input register 906C, using techniques similar to those described herein. The value previously stored in the third position of the input register 906C (in this example, the data value designated as “33”) is transmitted using the input register vias 616 to the input register 906B. Said data value is stored in the third position of the input register 906B. The value previously stored in the third position of the input register 906B (in this example, the data value designated as “23”) is transmitted using the input register vias 616 to the input register 906A. Said data value is written to, and overwrites, the data value designated as “13” in the third position of the input register 906. This process repeats until output data value 1208 for each iteration of the convolution operation is generated for all positions of the convolutional filters, as described herein. Although only a single output data value 1208 is shown here, it should be understood that respective output values can be generated for each column of weight values 908 stored by the MAC tiles 904, each of which can correspond to a respective 2D convolutional filter.

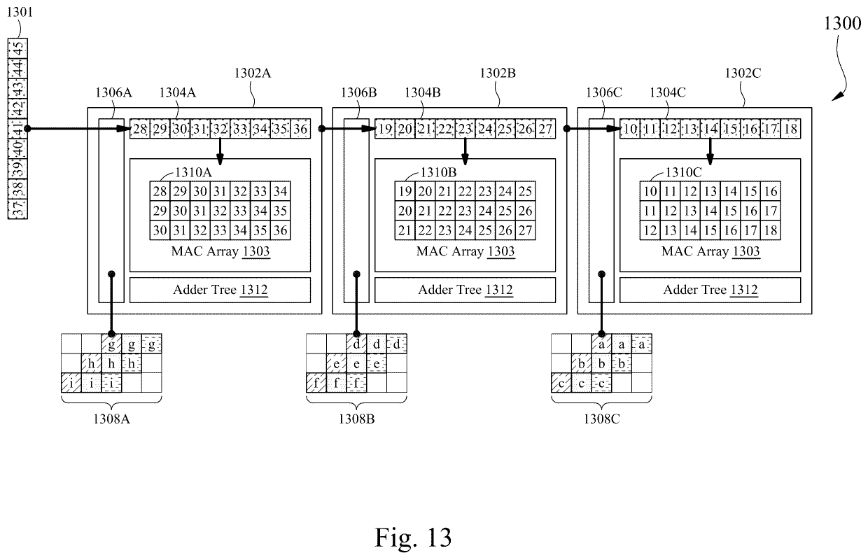

Referring to FIG. 13 in the context of the components described in connection with FIG. 1, illustrated is a block diagram of an example implementation of a MAC circuit 1300 using an input stationary configuration, in accordance with some embodiments of the present disclosure. The MAC circuit 1300 shown in FIG. 13 can be used to implement any artificial intelligence operation involving a MAC operation. For example, the MAC circuit 1300 can be used to perform convolution operations (e.g., for one layer of a convolutional neural network, etc.). In some implementations, although not explicitly shown here for visual clarity, the MAC circuit 1300 can include an activation and pooling circuit (e.g., the activation and pooling circuit 116 of FIG. 1, etc.), which may perform one or more activation function operations and/or pooling operations on the convolutional output of the MAC circuit 1300.

The MAC circuit 1300 may include one or more logic gates and sub-circuits, each of which may be constructed from one or more logic gates. Logic gates are electronic devices that perform logical operations on one or more input signals to produce a single output signal. Various embodiments of the circuits and logic gates that implement the MAC circuit 1300 may include various transistors. The transistors described herein may have a certain type (n-type or p-type), but embodiments are not limited thereto. The transistors can be any suitable type of transistor including, but not limited to, MOSFET, CMOS transistors, PMOS, NMOS, BJT, high voltage transistors, high frequency transistors, PFETs/NFETs, FinFETs, planar MOS transistors with raised source/drains, nanosheet FETs, nanowire FETs, or the like.

The MAC circuit 1300 can be similar to tiled MAC circuit 100 of FIG. 1, varying in the manner in which weight values 1308A, 1308B, and 1308C (sometimes referred to as “weight values 1308” or “weight values 1308”) and input data 1301 are propagated and stored in the MAC circuit 1300. In prior examples, the weight values (e.g., the weight values 306A-306C, etc.), which represent portions of convolutional filters divided between the MAC tiles 102A-102, remain stored/applied in a constant configuration (e.g., the “stationary weight” configuration), while the input data was changed each cycle to enable the input data to “pass through,” and be applied to, each data value of input data (e.g., input data 312 of FIG. 3) to perform a convolution operation.

In this example, the MAC circuit 1300 can provide subdivided sets of input data values 1310A, 1310B, and 1310C (sometimes referred to as “input data values 1310”) to the MAC arrays 1303 of each MAC tile 1302A, 1302B, and 1302C (sometimes referred to as “MAC tile(s) 1302”), a shown. Each MAC array 1303 can be similar to the MAC arrays 110 or the MAC arrays 610 described in connection with FIGS. 1 and 6. Each MAC tile 1302 can be similar to the MAC tiles 102 or the MAC tiles 602 described in connection with FIGS. 1 and 6, respectively. Each data value of the set of input data values 1310 stored in each MAC array 1303 can represent a respectively multiplication circuit that receives the respective data value (designated with a number “10” through “45” in this example) as an operand to generate a product, as described herein. Products generated by the MAC array 1303 can be provided as input to the adder tree 1312, which may be similar to and include any of the structure and functionality of the adder trees 112 or the adder trees 612 of FIGS. 1 and 6, respectively.

The adder trees 1312 can provide their respective partial sums as output to a global accumulation circuit (e.g., the global accumulation circuit 114 of FIG. 1, etc.) to produce output for artificial intelligence operations (e.g., convolution operations, etc.). Although the MAC circuit 1300 is shown in a 2D configuration, such as tiled MAC circuit 100 described in connection with FIG. 1, it should be understood that the MAC circuit 1300 may be arranged in a 3D configuration, such as the tiled MAC circuit 600 described in connection with FIG. 6. Each MAC tile 1302 may include additional circuit elements/components to facilitate transmission of information between layers of the 3D configuration, in some implementations.

For example, in some implementations, the MAC circuit 1300 can include any number of input register vias (e.g., input register vias 616, etc.) to propagate input data (e.g., input data 1301, etc.) through the MAC tiles 1302. In some implementations, the MAC circuit 1300 can include any number of adder vias (e.g., adder vias 618, etc.) to propagate partial sum data through the MAC tiles 1302 to generate output data. In some implementations, one or more of the MAC tiles 1302 can include a partial sum adder circuit (e.g., the partial sum adder circuit 614), to generate partial sum values that are propagated through each layer of the 3D device. The output of the top layer of the MAC circuit 1300 may include an activation and pooling circuit and/or one or more output buffers, similar to those described in connection with FIGS. 1 and 6.

In the configuration shown in FIG. 13, the MAC circuit 1300 is shown as including three MAC tiles 1302. Each MAC tile 1302A, 1302B, and 1302C can include a weight storage buffer 1306A, 1306B, and 1306C (sometimes referred to as “weight storage buffer 1306,” etc.). The weight storage buffers 1306A, 1306B, and 1306C may include various logic/control circuitry, similar to that shown in connection with the input register 200 of FIG. 2, to selectively provide one or more weights of a corresponding of weight values 1308A, 1308B, and 1308C. respectively.

Each MAC tile 1302A, 1302B, and 1308C is shown as including an input buffer 1304A, 1304B, and 1304C (sometimes referred to as “input buffer(s) 1304”), respectively. The input buffers 1304 can include various registers, logic elements, and/or memory elements to store a set of input data values (e.g., the input data 312, the input data 402, etc.) for an artificial intelligence operation. In some implementations, the input buffers 1304 may include, and perform any of the functionality of, the input registers 108 or the input registers 200 of FIGS. 1 and 2. In this example, the input data values stored in each input buffer can include input data for a single row of input data, as shown with respect to the input data 312 and the input data 402 of FIGS. 3A and 4. Input data from one input buffer can be propagated to the next input buffer 1304, either in its entirety (e.g., bulk transfer of an entire row of input data), or iteratively (e.g., as described in connection with FIG. 3B, etc.).

In an example convolution operation of the MAC circuit 1300, the MAC tile 1302 can be activated to iteratively retrieve rows of input data for the convolution operation, until input data is stored in the input buffers 1304 of each MAC tile 1302, as shown. In this example, the MAC tile 1302C stores input data values designated “10” through “18” (e.g., the second row of input data 312, input data 402, etc.), the MAC tile 1302B stores input data values designated “19” through “27” (e.g., the third row of input data 312, input data 402, etc.), and the MAC tile 1302A stores input data values designated “28” through “36” (e.g., the fourth row of input data 312, input data 402, etc.). Once each of the input buffers 1304 store a corresponding row of input data, said input data can be provided to the MAC arrays 1303, as shown.

In this example, the MAC array 1303 may include one or more registers and/or memory elements that can store duplicated portions of the input data (e.g., the sets of input data values 1310A, 1310B, and 1310C) retrieved or received from the respective input buffer 1304A, 1304B, or 1304C of the corresponding MAC tile 1302A, 1302B, or 1302C, as shown. Information stored in the MAC array can be referred to as. As described herein, each data value of the set of input data values 1310 stored in each MAC array 1303 can represent a respectively multiplication circuit that receives the respective data value as an operand to generate a product.

The MAC tiles 1302 can then iteratively apply (e.g., multiply) the weight values 1308 by the input data values 1310 to generate a set of output products, which are provided to the adder trees 1312 to compute partial sums of the convolution operation. In this example, the weight values 1308 are each represented on a grid in a staggered configuration. From left to right, the staggered configuration indications the order in which the weight values are applied to each row of the input data values 1310. In some implementations, the weight values 1308 can be propagate through each row of the input data in a pipeline configuration, simultaneous with each other MAC tile 1302, to produce the partial sums of the convolution operation. As shown by varying shading, and similar to the weight values 306 of FIG. 3B, the weight values 1308 can include three respective rows of weight values of three separate 3×3 convolutional filters, such as the filters 308A, 308B, and 308C of FIG. 3A.

In an example operation of a set of first operations of the MAC tile 1302C, the weight values 1308C can be applied to the input data values 1310C to generate a corresponding set of products. In a first iteration/time period, the right-most weight value “a” can be applied to the input data “10” of the top row of the data values 1310C. In a second iteration/time period, the right-most weight value “a” can propagate to the next multiplication circuit in the MAC array 1303 and be applied to the input data value “11” of the top row of the data values 1310C. During the same second iteration/time period the middle weight value “a” can be applied to the input data value “10” of the top-row of the data values 1310C, and the right-most-weight value “b” can be applied to the weight value “11” of the second row of data values 1310C.

In a third iteration/time period, the right-most weight value “a” can propagate to the next multiplication circuit in the MAC array 1303 and be applied to the input data value “12” of the top row of the data values 1310C. During the same third iteration/time period, the middle weight value “a” and right-most weight value “b” can be propagated to the next multiplication circuits in the MAC array 1303, and applied to the input data value “11” of the top-row of the data values 1310C and the weight value “12” of the second row of data values 1310C, respectively. During the same third iteration/time period, the left-most weight value “a” can be applied to the data value “10” of the top row of data values 1310C, the middle weight value “b” can be applied to the data value “11” of the middle row of data values 1310C, and the right-most weight value “c” can be applied to the data value “12” of the bottom row of data values 1310C.

For each iteration, each other MAC tile 1302 can perform similar operations using its corresponding set of weight values 1308 and input data values 1310. Following the third iteration/time, the right-most weight values “a”, “b”, and “c” have been applied to data values “10”, “11”, and “12” to generate corresponding products that are provided to the adder tree 1312. The adder tree 1312 can generate a partial sum for a first iteration of the convolution operation (e.g., the convolutional filter 308A applied to the input data 312) corresponding to the weight values “a”, “b”, and “c” for the first convolution operation.

The MAC tiles 1302 can repeat this process by iteratively propagating the weight values 1308 through the set of input data values 1310 to generate corresponding partial sum outputs, as described herein, until the weight values 1308 have been applied to all of the input data values 1310 in the manner shown and described. Once all input data in the MAC array 1303 has been processed, the next row of input data 1301 can be retrieved/provided to the input buffer 1304A. The input data previously stored in the input buffer 1304A can be provided and stored by the input buffer 1304B, and the input data previously stored in the input buffer 1304B can be provided to and stored in the input buffer 1304C, overwriting the previous data stored in the input buffer 1304C. In some implementations, data from each input buffer 1304 can be iteratively replaced, as described in connection with FIG. 3B, during each iteration of applying the weight values 1308 to the input data values 1310 stored in the MAC array 1303.

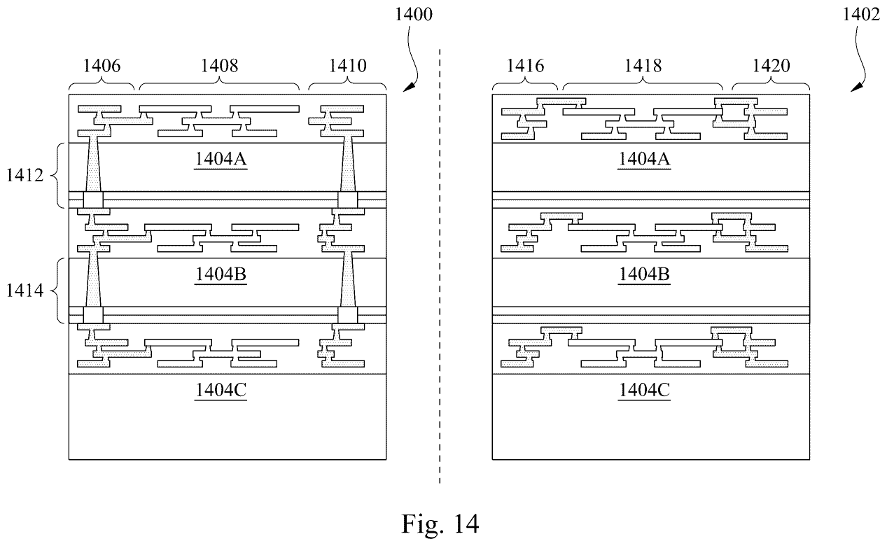

Referring to FIG. 14 in the context of the components described in connection with FIG. 6, illustrated are cross-sectional views 1400 and 1402 of an example semiconductor layout of the 3D tiled MAC circuits (e.g., the 3D tiled MAC circuit 600, etc.) described herein, in accordance with some embodiments of the present disclosure. The cross-sectional view 1400 shows an example cross-section of a tiled MAC circuit 600 including three MAC tiles 602. With reference to FIG. 6, the cross-sectional view is a view looking toward the input register 606, the input register vias 616, and the adder vias 618 from the MAC array 610, with the cross-sectional “cut” extending from the top of the MAC tile 602 to the bottom of the MAC tile 602 between the input register 606 and the MAC array 610.

The cross-sectional view 1400 shows the “front-to-back” integration of the different components of each MAC tile (e.g., the MAC tiles 602) within the via regions 1412 and 1414. As shown in the cross-sectional view 1400, the region 1406 corresponds to input register vias (e.g., the input register vias 616), the region 1410 corresponds to sets of adder vias (e.g., the adder vias 618), and the region 1408 corresponds to an input register (e.g., the input register 606). The MAC tile 602A, 602B, and 602C (with reference to FIG. 6) is defined on top the semiconductor layers 1404A, 1404B, and 1404C, respectively, as shown. The vias defined in the via region 1412 connect the MAC tile 602A to the MAC tile 602B, and the vias in the via region 1414 connect the MAC tile 602B to the MAC tile 602C (with reference to FIG. 6).

The cross-sectional view 1402 is a result of the same cross-sectional cut of the cross-sectional view 1400, except that the view is depicted as looking from the input register (e.g., the input register 606) toward the MAC array (e.g., the MAC array 610) of the MAC tile circuit (e.g., the MAC tile circuit 600). As shown, no vias in this region connect the MAC tiles defined on the semiconductor layers 1404A, 1404B, and 1404C. The region 1416 corresponds to the weight registers (e.g., the weight buffer 608), the region 1420 corresponds to the partial sum adder circuit(s) and/or adder trees circuits (e.g., the partial sum adder circuit 614 and/or the adder circuit 612), and the region 1418 corresponds to the MAC array (e.g., the MAC array 610) of each MAC tile.

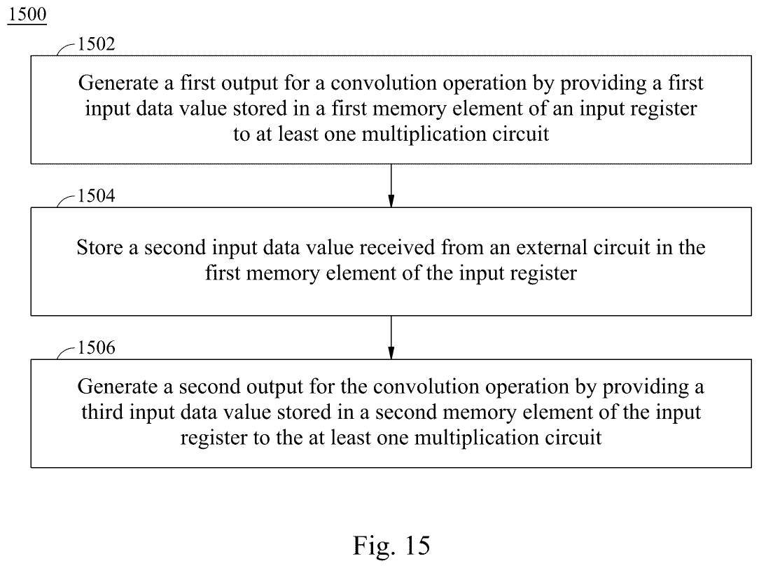

Referring to FIG. 15, illustrated is a flowchart of an example method 1500 to operate the disclosed circuits described herein, in accordance with some embodiments of the present disclosure. The method 1500 may be used to performance convolution operations or other artificial intelligence operations by reusing input data across multiple processing elements (e.g., MAC tiles 102, 602, 1302, etc.). The method 1500 may be performed in connection with any of the systems, devices, circuits, or components described herein. It is understood that additional operations may be provided before, during, and after the method 1500 of FIG. 15, and that some other operations may only be briefly described herein.

In brief overview, the method 1500 starts with operation 1502, including generating a first output for a convolution operation by providing a first input data value (e.g., data value “1” stored in a first memory element (e.g., a memory element 204 of FIG. 2) of an input register (e.g., the input register 108, 200, 606, etc.) to at least one multiplication circuit (e.g., MAC array 110, 610, etc.). the method 1500 proceeds with operation 1504, including storing a second input data value (e.g., data value “10” of FIG. 3B) received from an external circuit (e.g., a second MAC tile 102, 602, the input buffer 104, etc.) in the first memory element of the input register. The method 1500 proceeds with operation 1506, including generating a second output for the convolution operation by providing a third input data value (e.g., input data value “2” of FIG. 3B) stored in a second memory element of the input register to the at least one multiplication circuit.

Referring to operation 1502, a first output for a convolution operation is generated by providing a first input data value (e.g., data value “1” stored in a first memory element (e.g., a memory element 204 of FIG. 2) of an input register (e.g., the input register 108, 200, 606, etc.) to at least one multiplication circuit (e.g., MAC array 110, 610, etc.). Providing the input data may occur following a retrieval process in which the memory elements of the input register are populated with a row of input data (e.g., the top row of the input data 312, 402, etc.). The first output may be a product generated by multiplying the first input data value by a first weight value (e.g., the weight value “a” as shown in FIG. 3B).

Referring to operation 1504, a second input data value (e.g., data value “10” of FIG. 3B) received from an external circuit (e.g., a second MAC tile 102, 602, the input buffer 104, etc.) is stored in the first memory element of the input register. The second input data value may be a value of input data of a second row of the input data for the convolution operation. The second input data value may be provided from a second MAC circuit (e.g., the MAC tile 102A or 102B, the MAC tile 602A or 602B, etc.) or from an input data buffer (e.g., the input buffer 104, etc.). The second input data value can be stored in the same position as, and overwrite, the first input data value in the input register.

Referring to operation 1506, a second output for the convolution operation is generated by providing a third input data value (e.g., input data value “2” of FIG. 3B) stored in a second memory element of the input register to the at least one multiplication circuit. The second data value can be an adjacent (e.g., next) data value in the row of input data stored in the input register. The second memory element, in some implementations, can be adjacent to the first memory element in the input register. The second output can be at least one second product generated by multiplying the third input data value to a first weight value accessed or stored by the multiplication circuit. In some implementations, multiple products can be generated by providing the third input data value to multiple multiplication circuits, each accessing or storing a respective weight value for the convolution operation.

In some implementations, an adder circuit can generate a partial sum using at least the first output and the second output of the multiplication circuit(s). The partial sum can be a partial sum of an iteration of the convolution operation (e.g., convolution at a single sliding window position). In some implementations, the partial sum can be generated based on products produced using a single row of weight values of a convolutional filter (e.g., a convolution filter 308). In some implementations, a partial sum accumulation circuit of can generate a second partial sum by combining the partial sum generated by the adder circuit with a third partial sum received from a second external circuit. The partial sum accumulation circuit may receive the third partial sum using one or more adder vias. In some implementations, the partial sum accumulation circuit can provide second partial sum to the external circuit (e.g., that provided the second input data value) using the adder vias.

In one aspect of the present disclosure, a system is disclosed. The system includes an input buffer circuit storing a set of data values for a convolution operation. The system includes a plurality of MAC circuits. A first MAC circuit of the plurality of MAC circuits is configured to retrieve the set of data for the convolution operation. The first MAC circuit is configured to generate a first output by applying a first weight value stored at the first MAC circuit to a first data value of the set of data values. The first MAC circuit is configured to provide the first data value to a second MAC circuit of the plurality of MAC circuits. The first MAC circuit is configured to generate a plurality of second outputs by applying first weight value and a second weight value stored at the first MAC circuit to a second data value of the set of data values.

In another aspect of the present disclosure, a multiply-accumulate device is disclosed. The multiply-accumulate device includes a weight buffer circuit configured to store a set of weight values for a convolution operation. The multiply-accumulate device includes a set of multiplication circuits configured to generate a set of products for the convolution operation. The multiply-accumulate device includes an adder circuit configured to generate a partial sum for the convolution operation based on the set of products. The multiply-accumulate device includes an input register comprising a plurality of memory elements. The input register is configured to provide, to at least one of the set of multiplication circuits, a first input data value stored in a first memory element of the plurality of memory elements. The input register is configured to store a second input data value received from an external circuit in the first memory element of the plurality of memory elements. The input register is configured to provide, to the at least one of the set of multiplication circuits, a third input data value stored in a second memory element of the plurality of memory elements.

In yet another aspect of the present disclosure, a method is disclosed. The method includes generating, by a multiply-accumulate circuit, a first output for a convolution operation by providing a first input data value stored in a first memory element of an input register to at least one multiplication circuit. The method includes storing, by the multiply-accumulate circuit, a second input data value received from an external circuit in the first memory element of the input register. The method includes generating, by the multiply-accumulate circuit, a second output for the convolution operation by providing a third input data value stored in a second memory element of the input register to the at least one multiplication circuit.

As used herein, the terms “about” and “approximately” generally mean plus or minus 10% of the stated value. For example, about 0.5 would include 0.45 and 0.55, about 10 would include 9 to 11, about 1000 would include 900 to 1100.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A system, comprising:
an input buffer circuit storing a set of data values for a convolution operation; and
a plurality of multiply-accumulate (MAC) circuits, wherein a first MAC circuit of the plurality of MAC circuits is configured to:
retrieve the set of data for the convolution operation;
generate a first output by applying a first weight value stored at the first MAC circuit to a first data value of the set of data values;
provide the first data value to a second MAC circuit of the plurality of MAC circuits; and
generate a plurality of second outputs by applying first weight value and a second weight value stored at the first MAC circuit to a second data value of the set of data values.

2. The system of claim 1, further comprising a global accumulation circuit configured to generate an output of an iteration of the convolution operation based on a partial sum determined using the first output and at least one of the plurality of second outputs.

3. The system of claim 2, further comprising an activation and pooling circuit configured to generate a second convolution output by applying an activation operation or a pooling operation to the output of the global accumulation circuit.

4. The system of claim 3, wherein the activation and pooling circuit is further configured to store the second convolution output in the input buffer circuit.

5. The system of claim 1, wherein each of the plurality of MAC circuits further comprises a respective adder circuit, the respective adder circuit of the first MAC circuit configured to generate a first partial sum using the first output and at least one of the plurality of second outputs.

6. The system of claim 5, wherein the respective adder circuit of the second MAC circuit is configured to generate a second partial sum, the respective adder circuit of the first MAC circuit and the respective adder circuit of the second MAC circuit configured to provide the first partial sum and the second partial sum, respectively, to a global accumulation circuit.

7. The system of claim 1, wherein each of the plurality of MAC circuits comprises a respective input register, the second MAC circuit configured to:
generate a third output by applying a third weight value stored at the second MAC circuit to a third data value stored at a first position of the respective input register of the second MAC circuit;
receive the first data value from the first MAC circuit; and
store the first data value in the first position of the respective input register of the second MAC circuit.

8. The system of claim 1, wherein each of the plurality of MAC circuits comprises a respective weight buffer circuit, the respective weight buffer circuit of the first MAC circuit storing the first weight value and the second weight value.

9. A multiply-accumulate device, comprising:
a weight buffer circuit configured to store a set of weight values for a convolution operation;
a set of multiplication circuits configured to generate a set of products for the convolution operation;
an adder circuit configured to generate a partial sum for the convolution operation based on the set of products; and
an input register comprising a plurality of memory elements, the input register configured to:
provide, to at least one of the set of multiplication circuits, a first input data value stored in a first memory element of the plurality of memory elements;
store a second input data value received from an external circuit in the first memory element of the plurality of memory elements; and
provide, to the at least one of the set of multiplication circuits, a third input data value stored in a second memory element of the plurality of memory elements.

10. The multiply-accumulate device of claim 9, wherein the input register is further configured to:
receive an initial set of input data values from the external circuit; and
store each input data value of the initial set of input data values in a respective memory element of the plurality of memory elements.

11. The multiply-accumulate device of claim 9, wherein the input register further comprises an output multiplexer circuit configured to provide one input data value stored in one of the plurality of memory elements as output.

12. The multiply-accumulate device of claim 9, wherein the input register further comprises a decoder circuit configured to:
receive a write address for the first memory element of the plurality of memory elements; and
generate a write enable signal for the first memory element to store the second input data value.

13. The multiply-accumulate device of claim 9, wherein the adder circuit is configured to generate the partial sum using at least three of the set of products generated by the set of multiplication circuits.

14. The multiply-accumulate device of claim 9, wherein the adder circuit comprises a plurality of registers configured to store at least a subset of the set of products generated by the set of multiplication circuits.

15. The multiply-accumulate device of claim 9, further comprising a set of input register vias, the input register further configured to:
receive the second input data value using a first subset of the set of input register vias; and
provide the first input data value to a second external circuit using a second subset of the set of input register vias.

16. The multiply-accumulate device of claim 9, wherein the adder circuit comprises an adder tree.

17. The multiply-accumulate device of claim 9, further comprising a set of adder vias and a partial sum accumulation circuit, the partial sum accumulation circuit configured to:
generate a second partial sum based on the partial sum generated by the adder circuit and a third partial sum received from a second external circuit using the set of adder vias; and
provide the second partial sum to the external circuit using the set of adder vias.

18. A method, comprising:
generating, by a multiply-accumulate circuit, a first output for a convolution operation by providing a first input data value stored in a first memory element of an input register to at least one multiplication circuit;
storing, by the multiply-accumulate circuit, a second input data value received from an external circuit in the first memory element of the input register; and
generating, by the multiply-accumulate circuit, a second output for the convolution operation by providing a third input data value stored in a second memory element of the input register to the at least one multiplication circuit.

19. The method of claim 18, further comprising generating, by an adder circuit of the multiply-accumulate circuit, a partial sum using at least the first output and the second output.

20. The method of claim 19, further comprising:
generating, by a partial sum accumulation circuit of the multiply-accumulate circuit, a second partial sum based on the partial sum generated by the adder circuit and a third partial sum received from a second external circuit; and
providing, by the multiply-accumulate circuit, the second partial sum to the external circuit.
